(19) United States
(12) Patent Application Publication
(10) Pub. No.: US 2025/0132685 A1
(43) Pub. Date: Apr. 24, 2025

(54) MULTI-PHASE VOLTAGE CONVERTER CURRENT BALANCING

(71) Applicant: Advanced Energy Industries, Inc., Denver, CO (US)

(72) Inventor: James Sigamani, Manila (PH)

(21) Appl. No.: 18/985,399

(22) Filed: Dec. 18, 2024

Related U.S. Application Data
(63) Continuation-in-part of application No. 18/893,472, filed on Sep. 23, 2024.
Application No. 18/893,472 is a continuation of application No. 17/823,849, filed on Aug. 31, 2022, now Pat. No. 12,101,032.

(51) Int. Cl. H02M 3/335; H02M 3/00

(52) U.S. Cl. CPC H02M 3/33571; H02M 3/01

(57) ABSTRACT

A multi-phase power supply circuit comprises a first voltage converter stage, a resonant choke stage, and a transformer assembly. The resonant choke stage comprises a first and second resonant inductors electrically coupled with first and second voltage outputs of the first voltage converter stage. The transformer assembly comprises primary and secondary coil assemblies. Each primary coil assembly comprises first and second primary windings. The first primary winding comprises a first node electrically coupled with the resonant choke stage and a second node. The second primary winding comprises a first node and a second node electrically coupled with the resonant choke stage. The second nodes of the first primary windings are electrically coupled together, the first nodes of the second primary windings are electrically coupled together, and the first and second resonant inductors are wound about a first leg of a first magnetic core.

### CROSS-REFERENCE TO RELATED APPLICATIONS

This application is a continuation-in-part of US Application No. 18/893/472, filed Sep. 23, 2024, which is a continuation of U.S. application Ser. No. 17/823,849, filed Aug. 31, 2022. The entire disclosures of the above applications are incorporated herein by reference.

### TECHNICAL FIELD

Aspects of the disclosure are related to electronic components and in particular to components for three-phase power systems.

### BACKGROUND

Three-phase LLC power converters are commonly used in a variety of systems including telecom systems, fast chargers for electric vehicles, and other applications requiring high power density and high efficiency.

These three-phase LLC power converters typically include an inductor/transformer pair for each of the three phases. Current imbalance circulating among the primary currents due to differences in component value tolerances can negatively impact the converter efficiency and can even cause the converter to fail.

### SUMMARY

In accordance with one aspect of the present disclosure, a multi-phase power supply circuit comprises a first voltage converter stage, a resonant choke stage, and a transformer assembly electrically coupled with the resonant choke stage. The first voltage converter stage comprises a pair of voltage inputs and a pair of voltage outputs. The resonant choke stage comprises a first resonant inductor electrically coupled with a first voltage output of the pair of voltage outputs of the first voltage converter stage and comprises a second resonant inductor electrically coupled with a second voltage output of the pair of voltage outputs of the first voltage converter stage. The transformer assembly comprises a plurality of primary coil assemblies and a plurality of secondary coil assemblies. Each primary coil assembly of the plurality of primary coil assemblies comprises first and second primary windings. The first primary winding comprises a first node electrically coupled with the resonant choke stage and a second node. The second primary winding comprises a first node and a second node electrically coupled with the resonant choke stage. The second nodes of the first primary windings are electrically coupled together, the first nodes of the second primary windings are electrically coupled together, and the first and second resonant inductors are wound about a first leg of a first magnetic core.

In accordance with another aspect of the present disclosure, a method comprises coupling a first voltage output of a first voltage converter stage to a first resonant inductor of a resonant choke stage, coupling a second voltage output of the first voltage converter stage to a second resonant inductor of the resonant choke stage, and coupling a transformer assembly to the resonant choke stage. The transformer assembly comprises a plurality of primary coil assemblies, each primary coil assembly of the plurality of primary coil assemblies includes a first and a second primary winding. The first primary winding includes a first node electrically coupled to the resonant choke stage and a second node. The second primary winding includes a first node and a second node electrically coupled to the resonant choke stage. The method also comprises coupling the second nodes of the first primary windings together, coupling the first nodes of the second primary windings together, and winding the first and second resonant inductors about a first leg of a first magnetic core.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

In the drawings:

FIG. 1 is an exemplary three-phase power supply circuit including three LLC resonant voltage converters according to an embodiment.

FIG. 2 illustrates an exemplary single-phase LLC resonant voltage converter for use within the three-phase power supply circuit of FIG. 1, 5 or 8 according to an embodiment.

FIG. 3 is an embodiment of the three-phase power supply circuit of FIG. 1 according to an example.

FIG. 4 illustrates a winding arrangement of the transformer assembly of FIG. 3 on an exemplary unified core body according to an embodiment.

FIG. 5 illustrates an isometric view of a core body portion of FIG. 4 according to an embodiment.

FIG. 6 is an embodiment of the three-phase power supply circuit of FIG. 1 according to another embodiment.

FIG. 7 illustrates a winding arrangement of the transformer assembly of FIG. 6 on an exemplary unified core body according to an embodiment.

FIG. 8 illustrates a partial isometric view of the exemplary unified core body of FIG. 7 according to an embodiment.

FIG. 9 illustrates an exemplary single-phase LLC resonant voltage converter for use within the three-phase power supply circuit of FIG. 1, 3 or 6 according to an embodiment.

FIG. 10 illustrates an exemplary three-phase LLC resonant voltage converter for use within the three-phase power supply circuit of FIG. 1, 3 or 6 according to an embodiment.

FIG. 11 illustrates an exemplary three-phase power supply circuit including three LLC resonant voltage converters according to an embodiment.

FIG. 12 illustrates an exemplary single-phase LLC resonant voltage converter stage according to an embodiment.

FIG. 13 illustrates an exemplary single-phase LLC resonant voltage converter stage according to an embodiment.

FIG. 14 illustrates an exemplary embodiment of the LLC resonant voltage converter resonant choke stage according to an embodiment.

FIG. 15 illustrates an exemplary embodiment of the LLC resonant voltage converter resonant choke stage according to another embodiment.

FIG. 16 illustrates a transformer and secondary circuit block according to an embodiment.

FIG. 17 illustrates a winding arrangement of the transformer assembly of FIG. 15 on an exemplary pair of core arrangements according to an embodiment.

FIG. 18 illustrates a winding arrangement of the transformer assembly of FIG. 15 on an exemplary unified core arrangement according to an embodiment.

While the present disclosure is susceptible to various modifications and alternative forms, specific embodiments thereof have been shown by way of example in the drawings and are herein described in detail. It should be understood, however, that the description herein of specific embodiments is not intended to limit the present disclosure to the particular forms disclosed, but on the contrary, the intention is to cover all modifications, equivalents, and alternatives falling within the spirit and scope of the present disclosure. Note that corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

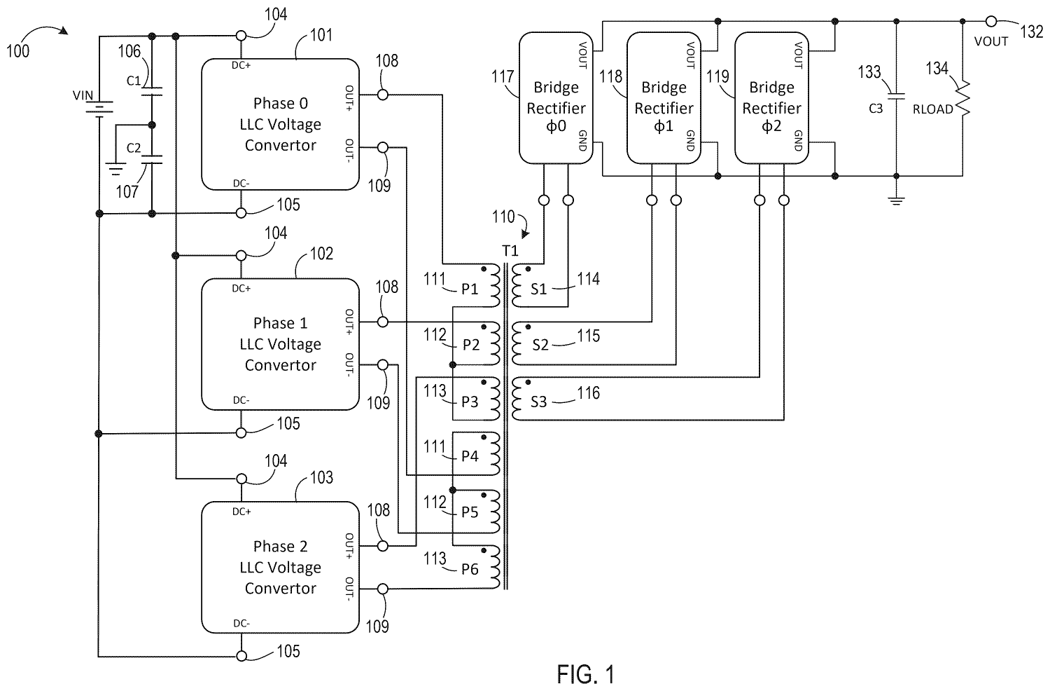

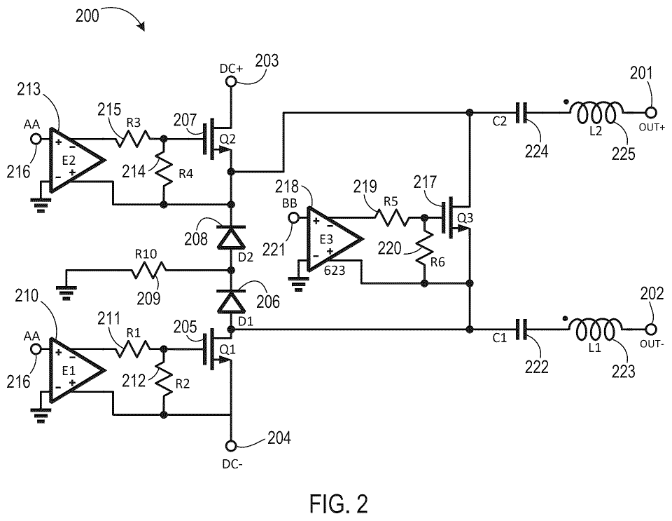

FIG. 1 illustrates an exemplary three-phase power supply circuit 100 including three LLC resonant voltage converters. This example power supply circuit 100 comprises three LLC resonant voltage converters 101, 102, 103, such as the LLC resonant voltage converters of FIGS. 2-10 described below.

Each of the three LLC resonant voltage converters 101, 102, and 103 includes a pair of voltage inputs 104, 105 (DC+ and DC−). An input voltage VIN is applied to the DC+ and DC− inputs 104, 105 of the voltage converters 101, 102, and 103 across capacitors C1 106 and C2 107, which act to divide the input voltage VIN in half when the values of C1 106 and C2 107 are the same.

Each of the three LLC resonant voltage converters 101, 102, and 103 includes a pair of voltage outputs 108, 109 (OUT+ and OUT−). A current generated by a voltage converter (e.g., 101) and supplied via its voltage output OUT+ 108, for example, flows through a transformer assembly T1 110, through the other two voltage converters (e.g., 102, 103), and returns through the voltage output OUT− 109. When supplied via the voltage output OUT− 109, the generated current returns to the voltage output OUT+ 108 after flowing through the voltage converters 102, 103 and the transformer assembly 110. In the embodiments of the voltage converters 101, 102, and 103 disclosed herein, conversion of the input voltage VIN to output currents requires the pair of voltage outputs 108, 109. LLC voltage converters with only a single output electrically coupled with a transformer assembly are not contemplated herein.

FIG. 2 illustrates an exemplary single-phase LLC resonant voltage converter 200 with a pair of voltage outputs 201, 202 for use within the three-phase power supply circuits disclosed herein. In this example embodiment, an input voltage is applied to inputs DC+ 203 and DC− 204 of the voltage converter 200. In some example embodiments the input voltage may be provided by a power factor correction circuit.

Switch Q1 205 and diode D1 206 make up a first half-bridge, and switch Q2 207 and diode D2 208 make up a second half-bridge. Diodes D1 206 and D2 208 are blocking diodes, which block current when switches Q1 205 and Q2 207 are turned on simultaneously. In one embodiment, a resistor R10 209 s included between diodes D1 206 and D2 208 to couple them to ground. In another embodiment, diodes D1 206 and D2 208 may be coupled to ground directly without resistor R10 209.

Switch Q1 205 is driven by isolated driver E1 210 and resistors R1 211 and R2 212. Switch Q2 207 driven by isolated driver E2 213 and resistors R3 214 and R4 215. Isolated drivers E1 213 and E2 213 are both driven by square wave AA 216 generated by a control circuit (not shown).

The maximum voltage stress on switches Q1 205 and Q2 207 is equal to half of the input voltage between DC+ 203 and DC− 204, while switch Q3 217 experiences the entire voltage stress of the input voltage between DC+ 203 and DC− 204. In an example embodiment, when the input voltage between DC+ 203 and DC− 204 is 440 volts, switches Q1 205 and Q2 207 may be rated for 300-400 volts, while Q3 217 is rated for 600-650 volts.

Switch Q3 217 is configured to short diodes D1 206 and D2 208 when it is activated by isolated driver E3 218 and resistors R5 219 and R6 220. Isolated driver E3 218 is driven by square wave BB 221 generated by a control circuit (not shown).

Each half-bridge drives one primary node of a primary coil of an external transformer through a capacitor/inductor pair. The first half-bridge comprising switch Q1 205 and diode D1 206 drives the external transformer primary coil through split resonant components capacitor C1 222 and inductor L1 223, electrically coupled in series. The second half-bridge comprising switch Q2 207 and diode D2 208 drives the external transformer primary coil through split resonant components capacitor C2 224 and inductor L2 225, electrically coupled in series. Output voltages OUT+ 201 and OUT− 202 are provided to first and second nodes of the primary coil assembly of an external transformer assembly as described herein. In the embodiment illustrated in FIG. 2, a resonant tank portion of the LLC resonant voltage converter 200 includes capacitors 222, 224 and inductors 223, 225.

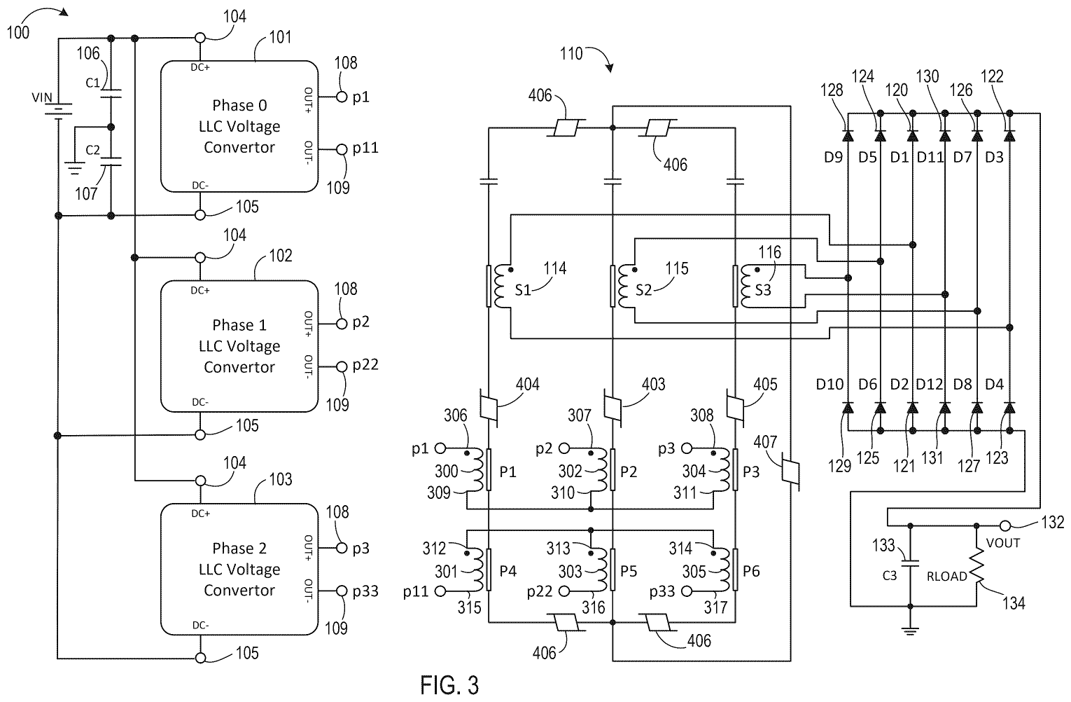

Referring back to FIG. 1 and to FIG. 3, the voltage outputs 108, 109 of each LLC resonant voltage converter 101-103 is electrically coupled with a respective primary winding assembly 111, 112, 113 of the transformer assembly 110. In a multi-phase interleaved LLC resonant voltage converter power supply such as that illustrated in FIG. 1, a current imbalance circulating among the primary currents due to differences in component value tolerances can negatively impact the converter efficiency. Accordingly, embodiments of the transformer assembly 110 disclosed herein combat current imbalance. As illustrated, the primary winding assembly 111 is formed from a pair of primary windings P1 300 and P4 301, the primary winding assembly 112 is formed from a pair of primary windings P2 302 and P5 303, and the primary winding assembly 113 is formed from a pair of primary windings P3 304 and P6 305. Thus, the primary winding assembly coupled to each LLC voltage converter includes a pair of primary windings.

Primary winding P1 300 includes a first node 306 at its dot end electrically coupled with the voltage output 108 of the LLC resonant voltage converter 101. Primary winding P2 302 includes a first node 307 at its dot end electrically coupled with the voltage output 108 of the LLC resonant voltage converter 102. Primary winding P3 304 includes a first node 308 at its dot end electrically coupled with the voltage output 108 of the LLC resonant voltage converter 103. Second nodes 309, 310, 311 opposite the dot ends of the primary windings P1-P3 are electrically coupled together.

First nodes 312, 313, 314 at the dot ends of the primary windings P4-P6 are electrically coupled together. Primary winding P4 301 includes a second node 315 opposite its dot end electrically coupled with the voltage output 109 of the LLC resonant voltage converter 101. Primary winding P5 303 includes a second node 316 opposite its dot end electrically coupled with the voltage output 109 of the LLC resonant voltage converter 102. Primary winding P6 305 includes a second node 317 opposite its dot end electrically coupled with the voltage output 109 of the LLC resonant voltage converter 103.

The total primary number of windings is P1+P4=P2+P5=P3+P6. Thus, the primary windings per phase are split into equal halves. In one embodiment, primary windings P1-P6 have an equal number of turns. The electrically coupled finish ends of the first half of windings (e.g., the second nodes 309-311 of windings P1-P3) are shorted together to form one floating star connection. Similarly, the start end of the second half of windings (e.g., the first nodes 312-314 of windings P4-P6) are connected to form another floating star connection. When electrically coupled with LLC voltage converters with split resonant components (e.g., capacitors 222, 224 and inductors 223, 225 LLC resonant voltage converter 200 of FIG. 2), an advantage related to substantially equal voltages with opposite polarity at the transformer terminals reduce common mode (CM) noise.

Three secondary windings S1-S3 114, 115, 116 of the transformer assembly 110 are inductively coupled with primary winding assemblies 111, 112, 113 and electrically coupled with respective bridge rectifiers 117, 118, 119. A current inductively generated in secondary winding 114 by primary winding assembly 111 drives diodes D1-D4 120-123 of the bridge rectifier 117. A current inductively generated in secondary winding 115 by primary winding assembly 112 drives diodes D5-D8 124-127 of the bridge rectifier 118. A current inductively generated in secondary winding 116 by primary winding assembly 113 drives diodes D9-D12 128-131 of the bridge rectifier 119. The output of the bridge rectifier 119 produces output voltage VOUT 132 across output filter capacitor C3 133 driving load resistance RLOAD 134.

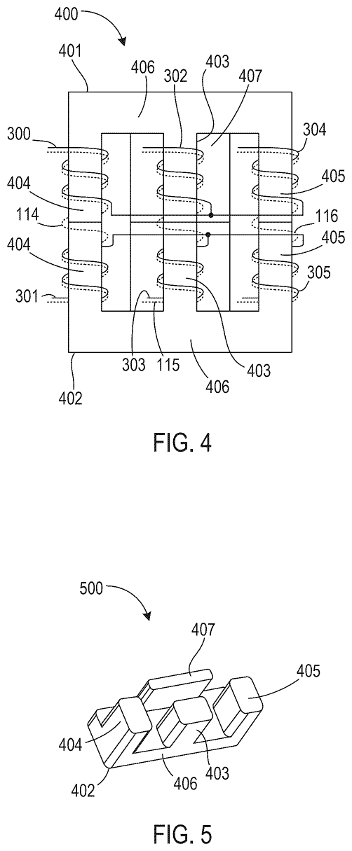

As illustrated in FIG. 4, a winding relationship is shown of the primary winding assemblies 111, 112, 113 and secondary windings 114, 115, 116 about a core 400 that together form a three-phase magnetics assembly. The core 400 has an upper E portion 401 and a lower E portion 402. Each portion 401, 402 has a central leg or limb portion 403 and first and second outer legs or limb portions leg 404, 405. In addition, a base portion 406 of each core portion 401, 402 is joined to the legs 403-405. The arrangement of the primary winding assemblies 111, 112, 113 and secondary windings 114, 115, 116 about the core legs 403-405 results in a sum of the flux in the winding legs that is not zero. As such, a common core return leg 407 is provided for the windings on the core legs 403-405. Magnetic fluxes from the three phases (e.g., LLC resonant voltage converters 101, 102, 103) within the core return leg 407 act to provide a path for the third harmonic flux.

FIG. 5 illustrates an isometric view of a core body 500 of the exemplary lower E portion 402 of the core 400 of FIG. 4 according to an embodiment. Another core body (not shown) mirroring the core body 500 may be used for the upper E portion 401. The two core bodies may have the respective primary windings 300-305 wound thereabout together with the secondary windings 114-116 and joined to form the completed core 400 illustrated in FIG. 4.

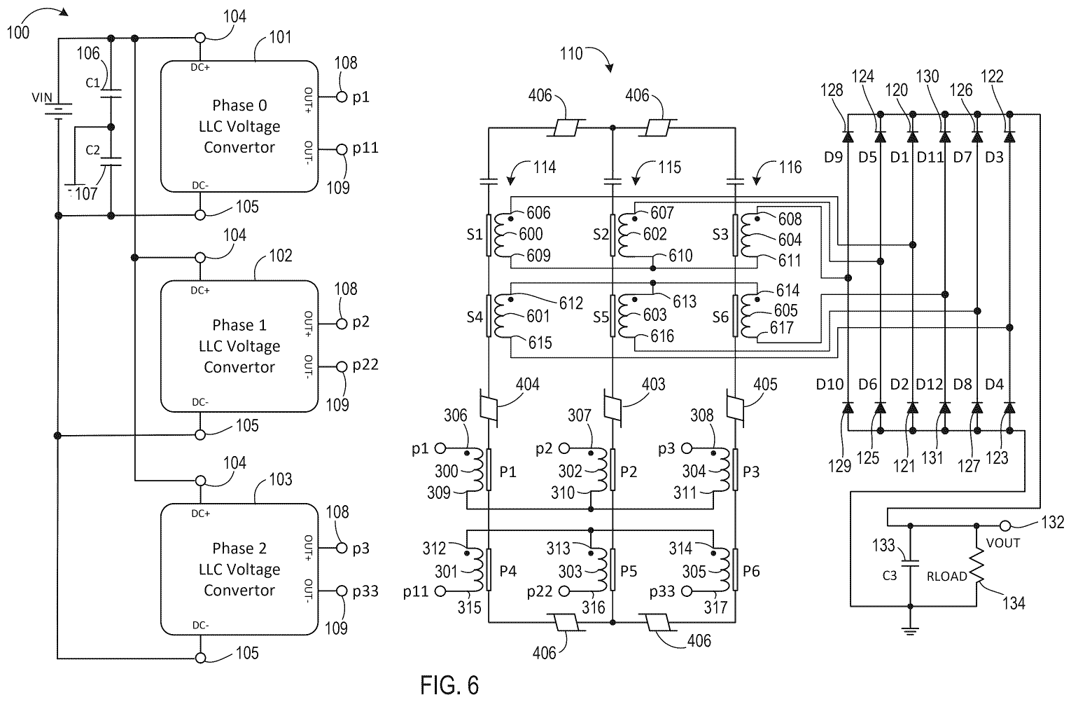

FIG. 6 illustrates an embodiment of the three-phase power supply circuit of FIG. 1 according to another embodiment. Similar to the embodiment illustrated in FIG. 3, the power supply circuit of FIG. 6 includes star-connected primary windings 300-305. In addition, the secondary winding assemblies 114-116 are also star-connected.

As illustrated, the secondary winding assembly 114 is formed from a pair of secondary windings S1 600 and S4 601, the secondary winding assembly 115 is formed from a pair of secondary windings S2 602 and S5 603, and the secondary winding assembly 116 is formed from a pair of secondary windings S3 604 and S6 605. Thus, the secondary winding assembly coupled to each bridge rectifiers 117-119 includes a pair of secondary windings.

Secondary winding 600 includes a first node 606 at its dot end electrically coupled with the diode pair D1, D2 of the bridge rectifier 117. Secondary winding 602 includes a first node 607 at its dot end electrically coupled with diode pair D5, D6 of the bridge rectifier 118. Secondary winding 604 includes a first node 608 at its dot end electrically coupled with the diode pair D9, D10 of the bridge rectifier 119. Second nodes 609, 610, 611 opposite the dot ends of the secondary windings 600, 602, 604 are electrically coupled together.

First nodes 612, 613, 614 at the dot ends of the secondary windings 601, 603, 605 are electrically coupled together. Secondary winding 601 includes a second node 615 opposite its dot end electrically coupled with the diode pair D3, D4 of the bridge rectifier 117. Secondary winding P5 303 includes a second node 616 opposite its dot end electrically coupled with the diode pair D7, D8 of the bridge rectifier 118. Secondary winding P6 305 includes a second node 617 opposite its dot end electrically coupled with the diode pair D11, D12 of the bridge rectifier 119.

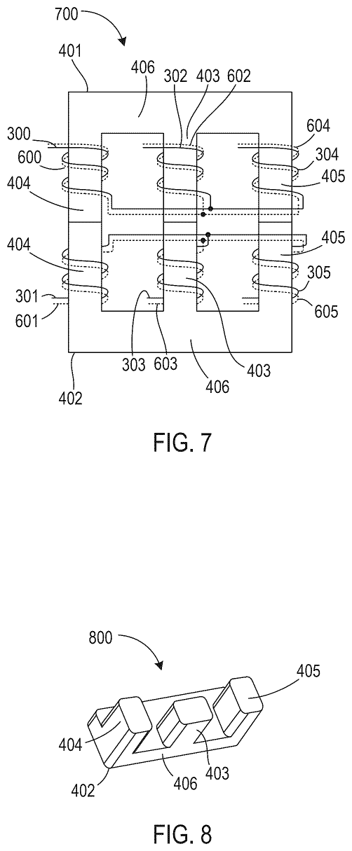

As illustrated in FIG. 7, a winding relationship is shown of the primary winding assemblies 111, 112, 113 and secondary winding assemblies 114, 115, 116 about a core 700 that together form a three-phase magnetics assembly. As described above with respect to FIGS. 4 and 5, the sum of the flux in the winding legs are not zero. In contrast and with regard to the circuit arrangements illustrated in FIGS. 6 and 7, because of the star connection of both the primary windings 300-305 and the secondary windings 600-602 and 603-605, the sum of the flux in the winding legs is zero or a negligible value. Thus, the core 700 may be implemented using the structure of the core 400 of FIG. 4 without the core return leg 407. Thus, FIG. 8 illustrates an isometric view of a core body 800 of the exemplary lower E portion 402 of the core 700 that includes the legs 403-405 about which the primary and secondary winding assemblies 111-116 are wound. The core return leg 407 of FIG. 5 is not needed.

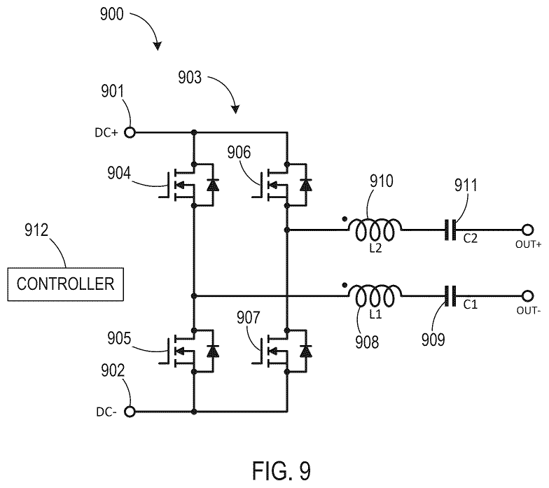

FIG. 9 illustrates an exemplary single-phase LLC resonant voltage converter 900 for use as an LLC resonant voltage converter (e.g., such as converters 101, 102, 103) according to an embodiment. The LLC voltage converter 900 is shown implemented as a resonant full-bridge LLC series converter and has a voltage input formed from a pair of voltage input terminals DC+ and DC− 901, 902 that are coupleable with the input voltage VIN illustrated in FIG. 1. The LLC voltage converter 900 includes a switching bridge 903 having a first pair of power switches 904, 905 coupled in series and in parallel with the respective voltage inputs and a second pair of power switches 906, 907 coupled in series and in parallel with the respective voltage inputs. A first resonant inductor 908 is serially coupled between the first pair of power switches 904, 905 and a first resonant capacitor 909. A second resonant inductor 910 is serially coupled between the second pair of power switches 906, 907 and a second resonant capacitor 911.

A controller 912 is coupled to control the power switches 904-907 using pulse-width modulation (PWM) signals in a synchronous manner such that power conversion in the voltage converter 900 is in out of phase with the power conversion in the other voltage converters 102, 103 such as with a phase difference of 120°. For example, the PWM signals may control the on and off states of the power switches 904, 907 together and the on and off states of the power switches 905, 906 together.

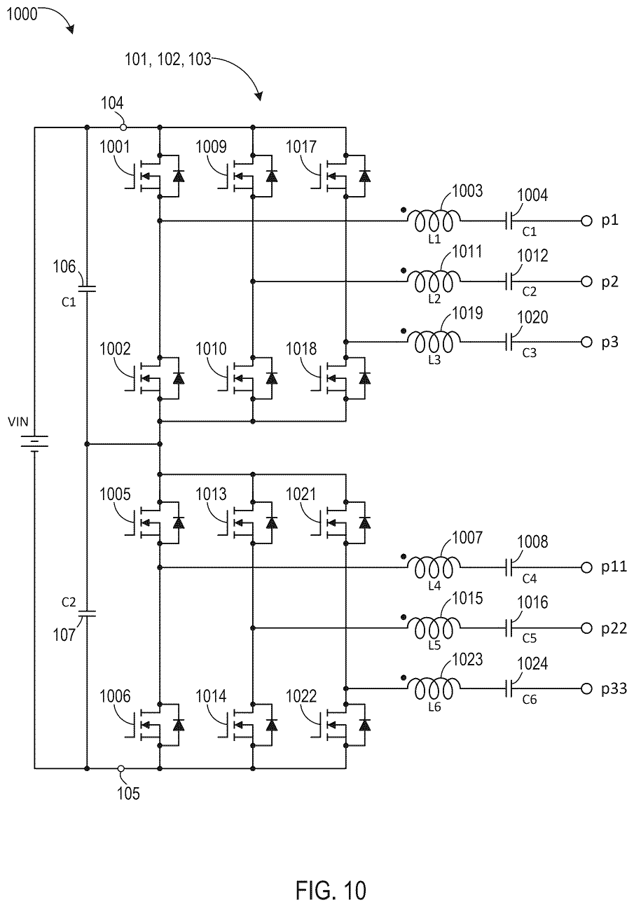

FIG. 10 illustrates an exemplary three-phase LLC resonant voltage converter 1000 according to another embodiment. In this embodiment, each of the LLC resonant voltage converters 101-103 includes two sets of power switch pairs coupled with respective resonant inductors and capacitors. The LLC resonant voltage converter 101 includes a first pair of power switches 1001, 1002 coupled with a resonant inductor 1003 and a resonant capacitor 1004. The LLC resonant voltage converter 101 also includes a second pair of power switches 1005, 1006 coupled with a resonant inductor 1007 and a resonant capacitor 1008. The LLC resonant voltage converters 102, 103 are similarly constructed. For example, the LLC resonant voltage converter 102 includes power switches 1009, 1010, resonant inductor 1011, and resonant capacitor 1012 in a first arrangement and includes power switches 1013, 1014, resonant inductor 1015, and resonant capacitor 1016 in a second arrangement. The LLC resonant voltage converter 103 includes power switches 1017, 1018, resonant inductor 1019, and resonant capacitor 1020 in a first arrangement and includes power switches 1021, 1022, resonant inductor 1023, and resonant capacitor 1024 in a second arrangement. As illustrated, the first pairs of power switches ((1001, 1002), (1009, 1010), (1017, 1018)) are coupled in parallel, and the second pairs of power switches ((1005, 1006), (1013, 1014), (1021, 1022)) are coupled in parallel. The first pairs of switches are further coupled in series with the second set pairs of power switches. Additionally, the series-connected first and second pairs of switches are coupled in parallel with the input voltage VIN.

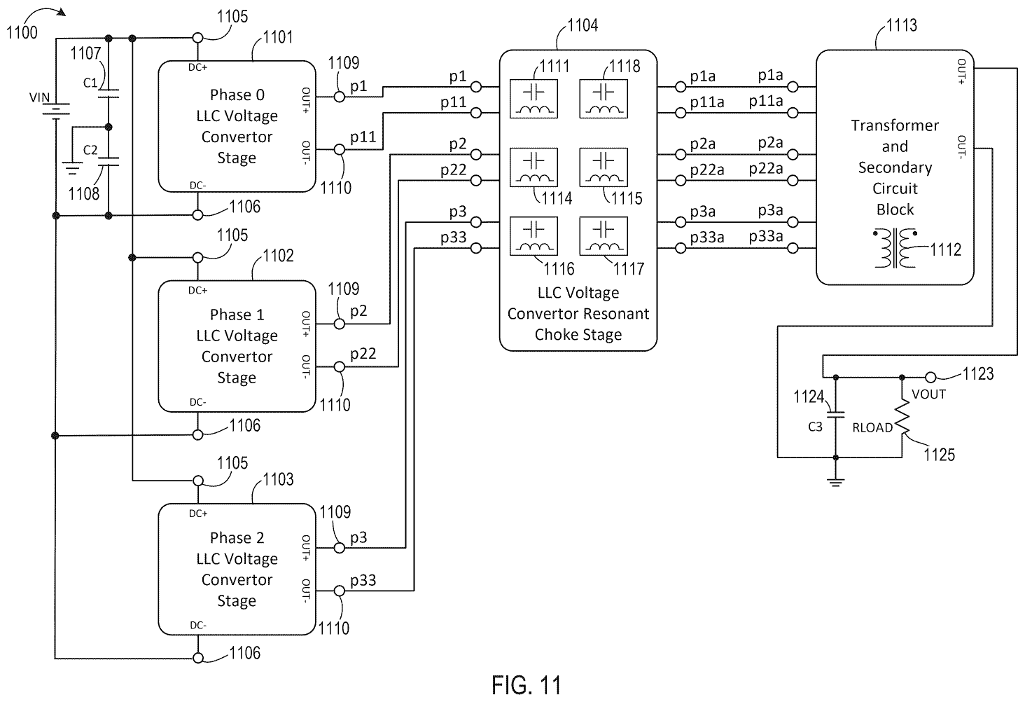

FIG. 11 illustrates an exemplary three-phase power supply circuit 1100 including three LLC resonant voltage converters. This example power supply circuit 1100 comprises three LLC resonant voltage converter stages 1101, 1102, 1103 and an LLC resonant voltage converter resonant choke stage 1104. Together the LLC resonant voltage converter stages 1101-1103 and the LLC resonant voltage converter resonant choke stage 1104 form three LLC voltage converters.

Each of the three LLC resonant voltage converter stages 1101, 1102, and 1103 includes a pair of voltage inputs 1105, 1106 (DC+ and DC−). An input voltage VIN is applied to the DC+ and DC− inputs 1105, 1106 of the voltage converter stages 1101, 1102, and 1103 across capacitors C1 1107 and C2 1108, which act to divide the input voltage VIN in half when the values of C1 1107 and C2 1108 are the same.

Each of the three LLC resonant voltage converter stages 1101, 1102, and 1103 includes a pair of voltage outputs 1109, 1110 (OUT+ and OUT−). A current generated by a voltage converter stage (e.g., 1101) and supplied via its voltage output OUT+ 1109, for example, flows through a first resonant capacitor and resonant inductor pair 1111 of the LLC resonant voltage converter resonant choke stage 1104, through a transformer assembly T1 1112 of a transformer and secondary circuit block 1113, through other resonant capacitor and resonant inductor pairs 1114, 1115, 1116, 1117, through the other two voltage converter stages (e.g., 1102, 1103), through another resonant capacitor and resonant inductor pair 1118, and returns through the voltage output OUT− 1110. When supplied via the voltage output OUT− 1110, the generated current returns to the voltage output OUT+ 1109 after flowing through the resonant capacitor and resonant inductor pair 1118, the voltage converter stages 1102, 1103, the resonant capacitor and resonant inductor pairs 1114-1117, the transformer block 1112, and the resonant capacitor and resonant inductor pair 1111. In the embodiments of the voltage converter stages 1101, 1102, and 1103 disclosed herein, conversion of the input voltage VIN to output currents requires the pair of voltage outputs 1109, 1110. LLC voltage converters with only a single output electrically coupled with a transformer assembly are not contemplated herein.

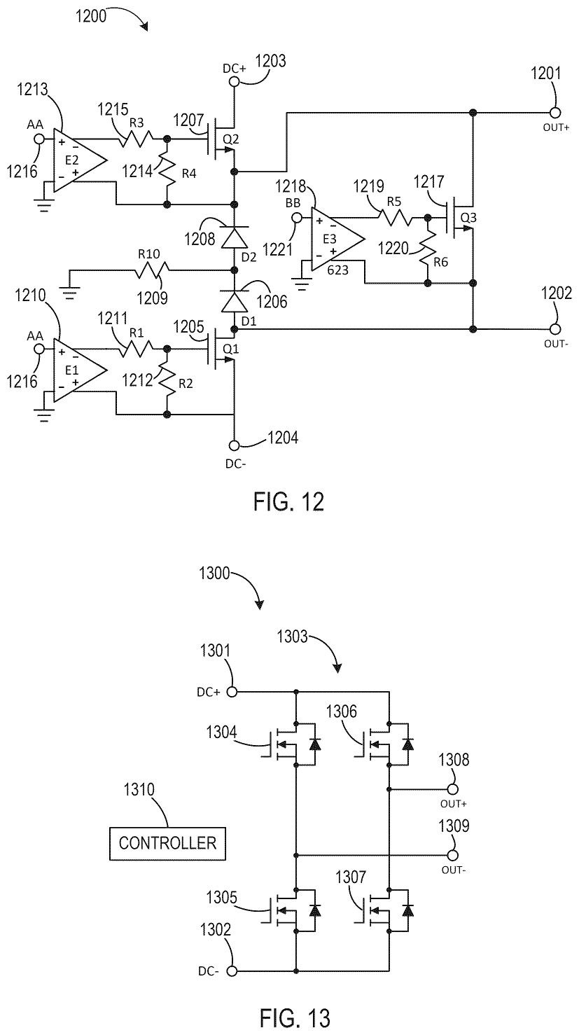

FIG. 12 illustrates an exemplary single-phase LLC resonant voltage converter stage 1200 with a pair of voltage outputs 1201, 1202 for use within the three-phase power supply circuits disclosed herein. In this example embodiment, an input voltage is applied to inputs DC+ 1203 and DC− 1204 of the voltage converter 1200. In some example embodiments, the input voltage may be provided by a power factor correction circuit.

Switch Q1 1205 and diode D1 1206 make up a first half-bridge, and switch Q2 1207 and diode D2 1208 make up a second half-bridge. Diodes D1 1206 and D2 1208 are blocking diodes, which block current when switches Q1 1205 and Q2 1207 are turned on simultaneously. In one embodiment, a resistor R10 1209 is included between diodes D1 1206 and D2 1208 to couple them to ground. In another embodiment, diodes D1 1206 and D2 1208 may be coupled to ground directly without resistor R10 1209.

Switch Q1 1205 is driven by isolated driver E1 1210 and resistors R1 1211 and R2 1212. Switch Q2 1207 driven by isolated driver E2 1213 and resistors R3 1214 and R4 1215. Isolated drivers E1 1213 and E2 1213 are both driven by square wave AA 1216 generated by a control circuit (not shown).

The maximum voltage stress on switches Q1 1205 and Q2 1207 is equal to half of the input voltage between DC+ 1203 and DC− 1204, while switch Q3 1217 experiences the entire voltage stress of the input voltage between DC+ 1203 and DC− 1204. In an example embodiment, when the input voltage between DC+ 1203 and DC− 1204 is 440 volts, switches Q1 1205 and Q2 1207 may be rated for 300-400 volts, while Q3 1217 is rated for 600-650 volts.

Switch Q3 1217 is configured to short diodes D1 1206 and D2 1208 when it is activated by isolated driver E3 1218 and resistors R5 1219 and R6 1220. Isolated driver E3 1218 is driven by square wave BB 1221 generated by a control circuit (not shown).

Each half-bridge drives one primary node of a primary coil of an external transformer (e.g., transformer assembly 1112 of FIG. 11) through a resonant capacitor/inductor pair (e.g., resonant capacitor/inductor pairs 1111, 1114, 1115 of FIG. 11). The first half-bridge comprising switch Q1 1205 and diode D1 1206 drives the external transformer primary coil through split resonant capacitor and inductor components electrically coupled in series. The second half-bridge comprising switch Q2 1207 and diode D2 1208 drives the external transformer primary coil through different split resonant capacitor and inductor components electrically coupled in series. Output voltages OUT+ 1201 and OUT− 1202 are provided to first and second nodes of the primary coil assembly of an external transformer assembly as described herein.

FIG. 13 illustrates an exemplary single-phase LLC resonant voltage converter stage 1300 for use as an LLC resonant voltage converter stage (e.g., such as converter stages 1101, 1102, 1103) according to another embodiment. The LLC voltage converter stage 1300 is shown implemented as a resonant full-bridge LLC series converter and has a voltage input formed from a pair of voltage input terminals DC+ and DC− 1301, 1302 that are coupleable with the input voltage VIN illustrated in FIG. 11. The LLC voltage converter stage 1300 includes a switching bridge 1303 having a first pair of power switches 1304, 1305 coupled in series and in parallel with the respective voltage inputs and a second pair of power switches 1306, 1307 coupled in series and in parallel with the respective voltage inputs. A pair of voltage outputs 1308, 1309 are coupled to resonant capacitor/inductor pairs (e.g., resonant capacitor/inductor pairs 1111, 1114, 1115 of FIG. 11) similar to the voltage outputs 1201, 1202 of FIG. 12 described above.

A controller 1310 is coupled to control the power switches 1304-1307 using pulse-width modulation (PWM) signals in a synchronous manner such that power conversion in the voltage converter stage 1300 is in out of phase with the power conversion in the other voltage converters 1102, 1103 such as with a phase difference of 120°. For example, the PWM signals may control the on and off states of the power switches 1304, 1307 together and the on and off states of the power switches 1305, 1306 together.

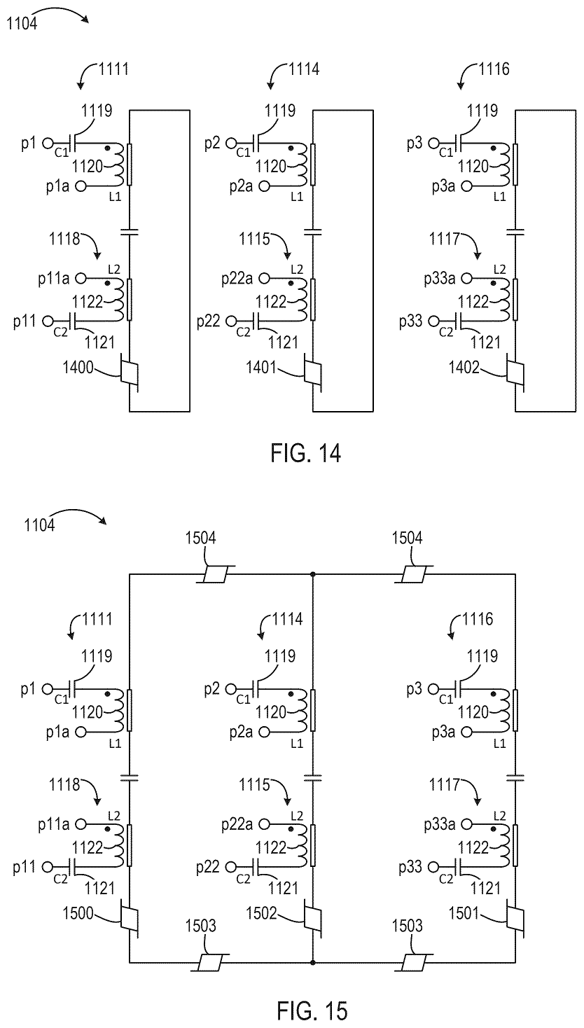

FIG. 14 illustrates an exemplary embodiment of the LLC resonant voltage converter resonant choke stage 1104 according to an embodiment. As shown, each of the resonant capacitor and resonant inductor pairs 1111, 1114, 1116 includes a resonant capacitor C1 1119 and resonant inductor L1 1120 while each of the resonant capacitor and resonant inductor pairs 1115, 1117, 1117 includes a resonant capacitor C2 1121 and resonant inductor L2 1122.

In the embodiment illustrated in FIG. 14, the inductors 1120, 1122 of the resonant capacitor/inductor pairs 1111, 1118 are wound about a single core 1400. The inductors 1120, 1122 of the resonant capacitor/inductor pairs 1114-1115 are wound about another single core 1401. The inductors 1120, 1122 of the resonant capacitor/inductor pairs 1116-1117 are wound about another single core 1402. Cores 1400-1402 may be, for example, UU cores, UI cores, EE cores, EI cores or any combination thereof. The resonant capacitor/inductor pairs are wound about the cores 1400-1402 as shown to ensure current balancing between star-connected primary windings of the transformer assembly 1112 while the star connection itself balances the current between the three phases of the LLC resonant voltage converter stages 1101, 1102, 1103.

FIG. 15 shows an arrangement of the LLC resonant voltage converter resonant choke stage 1104 illustrated in FIG. 14 according to another embodiment. As shown, the inductors 1120, 1122 of the resonant capacitor/inductor pairs 1111, 1118 are wound about an outer core leg 1500 such as the core 400 shown in FIG. 4, the inductors 1120, 1122 of the resonant capacitor/inductor pairs 1114-1115 are wound about another outer core leg 1501, and the inductors 1120, 1122 of the resonant capacitor/inductor pairs 1116-1117 are wound about a central core leg 1502. A first core base portion 1503 and a second core base portion 1504 join the core legs 1500-1502. The core (formed by legs and base portions 1500-1504) of FIG. 15 may represent a three-phase EE core or an EI core and provides the same current balancing benefits discussed above with respect to the cores 1400, 1401, 1402 while presenting a lower footprint and having lower losses due to a smaller volume of the integrated core compared to three separate cores (e.g., such as cores 1400, 1401, 1402).

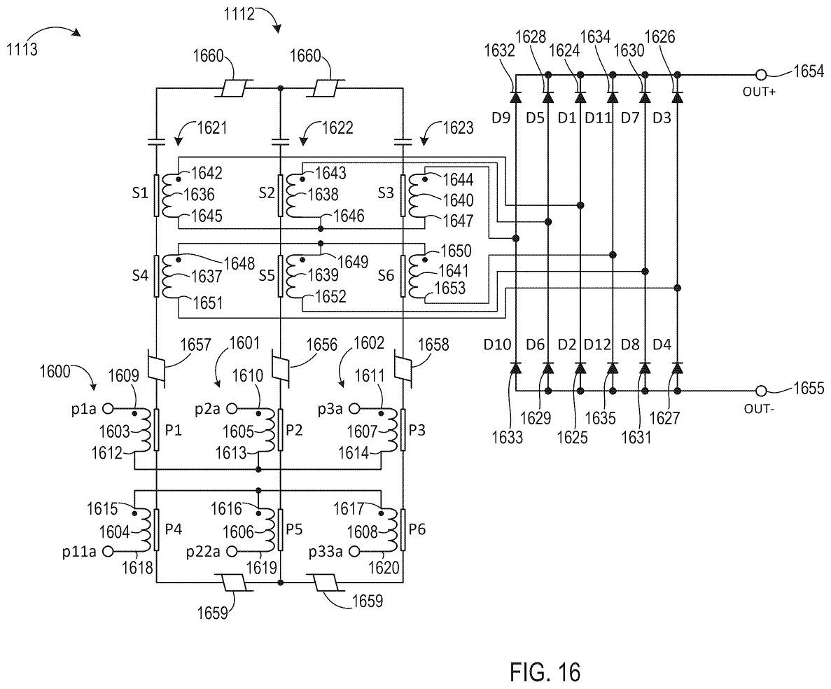

FIG. 16 illustrates an embodiment of the transformer and secondary circuit block 1113 of FIG. 11 according to an embodiment. The transformer assembly 1112 includes three primary winding assemblies 1600, 1601, 1602. In a multi-phase interleaved LLC resonant voltage converter power supply such as that illustrated in FIG. 11, a current imbalance circulating among the primary currents due to differences in component value tolerances can negatively impact the converter efficiency. Accordingly, embodiments of the transformer assembly 1112 disclosed herein combat current imbalance. As illustrated, the primary winding assembly 1600 is formed from a pair of primary windings P1 1603 and P4 1604, the primary winding assembly 1601 is formed from a pair of primary windings P2 1605 and P5 1606, and the primary winding assembly 1602 is formed from a pair of primary windings P3 1607 and P6 1608.

Primary winding P1 1603 includes a first node 1609 at its dot end electrically coupled with the voltage output 1109 of the LLC resonant voltage converter 1101. Primary winding P2 1605 includes a first node 1610 at its dot end electrically coupled with the voltage output 1109 of the LLC resonant voltage converter 1102. Primary winding P3 1607 includes a first node 1611 at its dot end electrically coupled with the voltage output 1109 of the LLC resonant voltage converter 1103. Second nodes 1612, 1613, 1614 opposite the dot ends of the primary windings P1-P3 are electrically coupled together.

First nodes 1615, 1616, 1617 at the dot ends of the primary windings P4-P6 are electrically coupled together. Primary winding P4 1604 includes a second node 1618 opposite its dot end electrically coupled with the voltage output 1110 of the LLC resonant voltage converter 1101. Primary winding P5 1606 includes a second node 1619 opposite its dot end electrically coupled with the voltage output 1110 of the LLC resonant voltage converter 1102. Primary winding P6 1608 includes a second node 1620 opposite its dot end electrically coupled with the voltage output 1110 of the LLC resonant voltage converter 1103.

The total primary number of windings is P1+P4=P2+P5=P3+P6. Thus, the primary windings per phase are split into equal halves. In one embodiment, primary windings P1-P6 have an equal number of turns. The electrically coupled finish ends of the first half of windings (e.g., the second nodes 1612-1614 of windings P1-P3) are shorted together to form one floating star connection. Similarly, the start end of the second half of windings (e.g., the first nodes 1615-1617 of windings P4-P6) are connected to form another floating star connection. When electrically coupled with LLC voltage converters with split resonant components (e.g., capacitors 1119, 1121 and inductors 1120, 1122 of LLC resonant voltage converter choke stage 1104), an advantage related to substantially equal voltages with opposite polarity at the transformer terminals reduce common mode (CM) noise.

Three secondary winding assemblies S1-S3 1621, 1622, 1623 of the transformer assembly 1112 are inductively coupled with primary winding assemblies 1600-1602 and electrically coupled with respective bridge rectifiers. Diodes D1-D4 1624-1627 form a first bridge rectifier (e.g., bridge rectifier 117 of FIG. 1). Diodes D5-D8 1628-1631 form a second bridge rectifier (e.g., bridge rectifier 118 of FIG. 1). Diodes D9-D12 1632-1635 form a third bridge rectifier (e.g., bridge rectifier 119 of FIG. 1).

As illustrated, the secondary winding assembly 1621 is formed from a pair of secondary windings S1 1636 and S4 1637, the secondary winding assembly 1622 is formed from a pair of secondary windings S2 1638 and S5 1639, and the secondary winding assembly 1623 is formed from a pair of secondary windings S3 1640 and S6 1641.

Secondary winding 1636 includes a first node 1642 at its dot end electrically coupled with the diode pair D1, D2 1624, 1625. Secondary winding 1638 includes a first node 1643 at its dot end electrically coupled with diode pair D5, D6 1628, 1629. Secondary winding 1640 includes a first node 1644 at its dot end electrically coupled with the diode pair D9, D10 1632, 1633. Second nodes 1645, 1646, 1647 opposite the dot ends of the secondary windings 1636, 1638, 1640 are electrically coupled together.

First nodes 1648, 1649, 1650 at the dot ends of the secondary windings 1637, 1639, 1641 are electrically coupled together. Secondary winding 1637 includes a second node 1651 opposite its dot end electrically coupled with the diode pair D3, D4 1626, 1627. Secondary winding P5 1606 includes a second node 1652 opposite its dot end electrically coupled with the diode pair D7, D8 1630, 1631. Secondary winding P6 1608 includes a second node 1653 opposite its dot end electrically coupled with the diode pair D11, D12 1634, 1635. As shown in FIGS. 11 and 16, voltage output 1654, 1655 of the transformer and secondary circuit block 1113 produces output voltage VOUT 1123 across output filter capacitor C3 1124 driving load resistance RLOAD 1125.

As illustrated in FIG. 16, a winding relationship is shown of the primary winding assemblies 1600-1602 and secondary windings assemblies 1621-1623 about a core that together form a three-phase magnetics assembly. The core includes a central leg or limb portion 1656 and first and second outer legs or limb portions 1657, 1658. In addition, base portion 1659, 1660 join the legs 1656-1658. In one embodiment, a common core return leg such as the core return leg 407 of FIG. 4 may be provided for the windings on the core legs 1656-1658. Magnetic fluxes from the three phases (e.g., LLC resonant voltage converters 1101, 1102, 1103) within the core return leg act to provide a path for the third harmonic flux.

In one embodiment, the primary winding assemblies 1600-1602 and secondary windings assemblies 1621-1623 about tightly wound about the core in a similar manner as that illustrated and discussed with respect to FIG. 4. Accordingly, a balanced layout is maintained in the secondary circuit block 1113, and impedance imbalances between the windings is avoided.

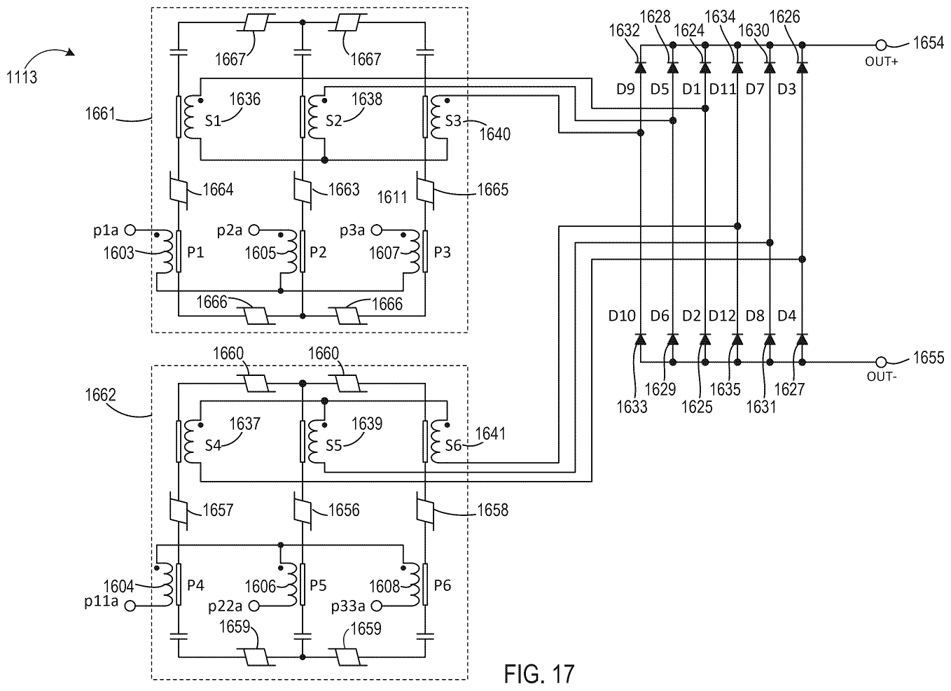

FIG. 17 illustrates an embodiment of the transformer and secondary circuit block 1113 of FIG. 16 according to an embodiment. As shown, the transformer and secondary circuit stage 1113 of FIG. 16 is split between two magnetic cores. In a first core arrangement 1661, the first core (including legs 1656-1658 and bases 1659-1660) continues to have primary windings 1604, 1606, 1608 and secondary windings 1637, 1639, 1641 wound thereon. In a second core arrangement 1662, a second core includes a central leg 1663 having primary winding 1605 and secondary winding 1638 wound thereon. A first outer leg 1664 has primary winding 1603 and secondary winding 1636 wound thereon. A second outer leg 1665 has primary winding 1607 and secondary winding 1640 wound thereon. A pair of core base portions 1666, 1667 join legs 1663-1665. The first and second core arrangements 1661, 1662 provides less restrictive tolerances to the layout of the rectification components coupled to the secondary windings 1636-1641.

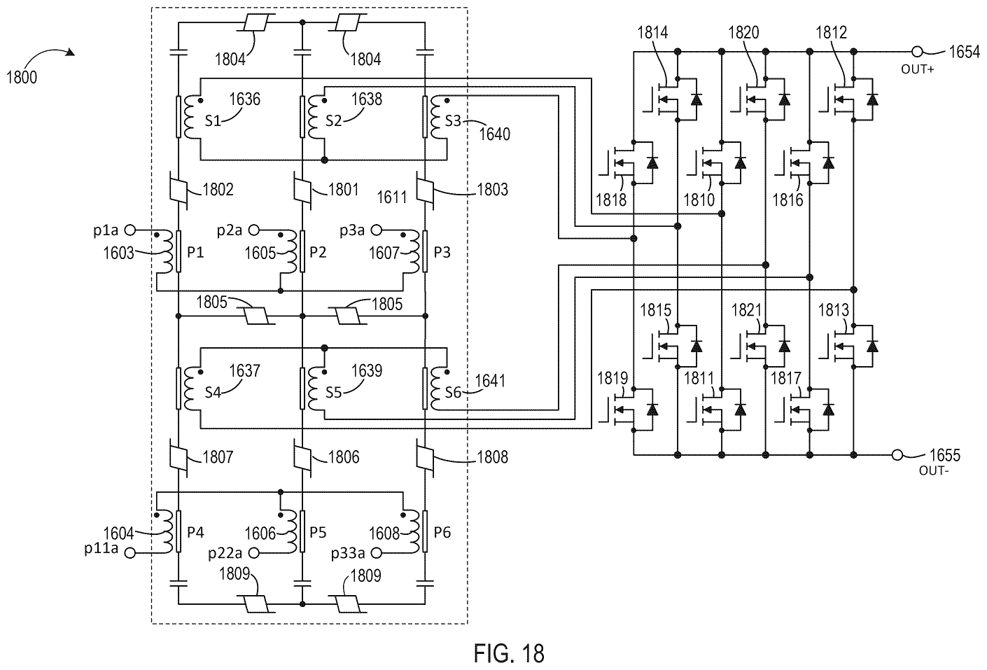

In another embodiment as illustrated in FIG. 18, a single core arrangement 1800 combining the advantages of the first and second core arrangements 1661, 1662 is illustrated. A single magnetic core includes a first central leg or limb portion 1801 and a first pair of outer legs or limb portions 1802, 1803. The central and outer legs 1801-1803 extend between a first base portion 1804 and a middle portion 1805. A second central leg or limb portion 1806 and a second pair of outer legs or limb portions 1807, 1808 extend between the middle portion 1805 and a second base portion 1809. The core formed by the legs and base portions 1801-1809 may be an EIE core in some examples.

FIG. 18 also shows a plurality of transistors 1810-1821 (e.g., metal-oxide-semiconductor field-effect transistor (MOSFETs)) replacing diodes 1624-1635 of FIG. 17. The transistors 1810-1821 may be controlled by a controller as synchronous rectifiers, for example. In addition to the diodes of FIG. 17, the diodes 1624-1635 of FIG. 16 may also be substituted by MOSFETs. Further, the transistors 1810-1821 of FIG. 18 may be replaced by diodes as shown in FIGS. 16 and 17. The diodes and transistors may be referred to herein as rectifier switches.

Based on the disclosures shown and discussed above with respect to FIGS. 11-18, a variety of three-phase LLC voltage converters with star-connected primary and secondary windings may be formed. In one embodiment, a voltage converter stage illustrated in FIG. 12 may be combined with the choke stage 1104 of FIG. 14 and the transformer and secondary circuit stage 1113 of FIG. 16.

In another embodiment, a voltage converter stage illustrated in FIG. 12 may be combined with the choke stage 1104 of FIG. 14 and the transformer and secondary circuit stage 1113 of FIG. 17.

In another embodiment, a voltage converter stage illustrated in FIG. 12 may be combined with the choke stage 1104 of FIG. 14 and the transformer and secondary circuit stage 1113 of FIG. 18.

In another embodiment, a voltage converter stage illustrated in FIG. 12 may be combined with the choke stage 1104 of FIG. 15 and the transformer and secondary circuit stage 1113 of FIG. 16.

In another embodiment, a voltage converter stage illustrated in FIG. 12 may be combined with the choke stage 1104 of FIG. 15 and the transformer and secondary circuit stage 1113 of FIG. 17.

In another embodiment, a voltage converter stage illustrated in FIG. 12 may be combined with the choke stage 1104 of FIG. 15 and the transformer and secondary circuit stage 1113 of FIG. 18.

In another embodiment, a voltage converter stage illustrated in FIG. 13 may be combined with the choke stage 1104 of FIG. 14 and the transformer and secondary circuit stage 1113 of FIG. 16.

In another embodiment, a voltage converter stage illustrated in FIG. 13 may be combined with the choke stage 1104 of FIG. 14 and the transformer and secondary circuit stage 1113 of FIG. 17.

In another embodiment, a voltage converter stage illustrated in FIG. 13 may be combined with the choke stage 1104 of FIG. 14 and the transformer and secondary circuit stage 1113 of FIG. 18.

In another embodiment, a voltage converter stage illustrated in FIG. 13 may be combined with the choke stage 1104 of FIG. 15 and the transformer and secondary circuit stage 1113 of FIG. 16.

In another embodiment, a voltage converter stage illustrated in FIG. 13 may be combined with the choke stage 1104 of FIG. 15 and the transformer and secondary circuit stage 1113 of FIG. 17.

In another embodiment, a voltage converter stage illustrated in FIG. 13 may be combined with the choke stage 1104 of FIG. 15 and the transformer and secondary circuit stage 1113 of FIG. 18.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the invention is not to be seen as limited by the foregoing description but is only limited by the scope of the appended claims.

1. A multi-phase power supply circuit comprising:
a first voltage converter stage comprising:
a pair of voltage inputs; and
a pair of voltage outputs;
a resonant choke stage comprising:
a first resonant inductor electrically coupled with a first voltage output of the pair of voltage outputs of the first voltage converter stage; and
a second resonant inductor electrically coupled with a second voltage output of the pair of voltage outputs of the first voltage converter stage;
a transformer assembly electrically coupled with the resonant choke stage and comprising:
a plurality of primary coil assemblies; and
a plurality of secondary coil assemblies; and
wherein each primary coil assembly of the plurality of primary coil assemblies comprises:
a first primary winding comprising:
a first node electrically coupled with the resonant choke stage; and
a second node; and
a second primary winding comprising:
a first node; and
a second node electrically coupled with the resonant choke stage;
wherein the second nodes of the first primary windings are electrically coupled together;
wherein the first nodes of the second primary windings are electrically coupled together; and
wherein the first and second resonant inductors are wound about a first leg of a first magnetic core.

2. The multi-phase power supply circuit of claim 1 further comprising:
a second voltage converter stage comprising a pair of voltage outputs; and
a third voltage converter stage comprising a pair of voltage outputs;
wherein the resonant choke stage further comprises:
a third resonant inductor electrically coupled with a first voltage output of the pair of voltage outputs of the second voltage converter stage;
a fourth resonant inductor electrically coupled with a second voltage output of the pair of voltage outputs of the second voltage converter stage;
a fifth resonant inductor electrically coupled with a first voltage output of the pair of voltage outputs of the third voltage converter stage; and
a sixth resonant inductor electrically coupled with a second voltage output of the pair of voltage outputs of the third voltage converter stage.

3. The multi-phase power supply circuit of claim 2, wherein the third and fourth resonant inductors are wound about a second leg of the first magnetic core;
wherein the fifth and sixth resonant inductors are wound about a third leg of the magnetic core; and
wherein the first, second, and third legs of the first magnetic core are joined together via a pair of core bases.

4. The multi-phase power supply circuit of claim 2, wherein the third and fourth resonant inductors are wound about a first leg of a second magnetic core; and
wherein the fifth and sixth resonant inductors are wound about a first leg of a third magnetic core.

5. The multi-phase power supply circuit of claim 1, wherein each secondary coil assembly of the plurality of secondary coil assemblies comprises:
a first secondary winding comprising a first node and a second node; and
a second secondary winding comprising a first node and a second node;
wherein the second nodes of the first secondary windings are electrically coupled together; and
wherein the first nodes of the second secondary windings are electrically coupled together.

6. The multi-phase power supply circuit of claim 5 further comprising a bridge rectifier assembly electrically coupled with the transformer assembly and comprising three bridge rectifiers;
wherein each bridge rectifier comprises:
a first pair of rectifier switches electrically coupled in series; and
a second pair of rectifier switches electrically coupled in series;
wherein the first pair of rectifier switches is electrically coupled in parallel with the second pair of rectifier switches; and
wherein the rectifier switches comprises one of a diode and a transistor.

7. The multi-phase power supply circuit of claim 5, wherein:
the first primary winding of a first primary coil assembly of the plurality of primary coil assemblies and the first secondary winding of a first secondary coil assembly of the plurality of secondary coil assemblies are wound about a first leg of a second magnetic core;
the first primary winding of a second primary coil assembly of the plurality of primary coil assemblies and the first secondary winding of a second secondary coil assembly of the plurality of secondary coil assemblies are wound about a second leg of the second magnetic core; and
the first primary winding of a third primary coil assembly of the plurality of primary coil assemblies and the first secondary winding of a third secondary coil assembly of the plurality of secondary coil assemblies are wound about a third leg of the second magnetic core.

8. The multi-phase power supply circuit of claim 7, wherein:
the second primary winding of the first primary coil assembly of the plurality of primary coil assemblies and the second secondary winding of the first secondary coil assembly of the plurality of secondary coil assemblies are wound about the first leg of the second magnetic core;
the second primary winding of the second primary coil assembly of the plurality of primary coil assemblies and the second secondary winding of the second secondary coil assembly of the plurality of secondary coil assemblies are wound about the second leg of the second magnetic core; and
the second primary winding of the third primary coil assembly of the plurality of primary coil assemblies and the second secondary winding of the third secondary coil assembly of the plurality of secondary coil assemblies are wound about the third leg of the second magnetic core.

9. The multi-phase power supply circuit of claim 7, wherein:
the second primary winding of the first primary coil assembly of the plurality of primary coil assemblies and the second secondary winding of the first secondary coil assembly of the plurality of secondary coil assemblies are wound about a first leg of a third magnetic core;
the second primary winding of the second primary coil assembly of the plurality of primary coil assemblies and the second secondary winding of the second secondary coil assembly of the plurality of secondary coil assemblies are wound about a second leg of the third magnetic core; and
the second primary winding of the third primary coil assembly of the plurality of primary coil assemblies and the second secondary winding of the third secondary coil assembly of the plurality of secondary coil assemblies are wound about a third leg of the third magnetic core.

10. The multi-phase power supply circuit of claim 1, wherein the first voltage converter stage comprises:
two switches and two diodes coupled in a three-level LLC circuit arrangement between the pair of voltage inputs and the pair of voltage outputs, the two switches and two diodes comprising:
a first switch and first diode configured as a first half-bridge;
a second switch and second diode configured as a second half-bridge; and
a third switch coupled across the first and second diodes to short circuit the first and second diodes in response to the third switch being in a conductive mode.

11. The multi-phase power supply circuit of claim 1, wherein the first voltage converter stage comprises a switch assembly comprising:
a first pair of switches electrically coupled in series; and
a second pair of switches electrically coupled in series;
wherein the first pair of switches is electrically coupled in parallel with the second pair of switches; and
wherein the first pair of switches is electrically coupled in parallel with the pair of voltage inputs.

12. A method comprising:
coupling a first voltage output of a first voltage converter stage to a first resonant inductor of a resonant choke stage;
coupling a second voltage output of the first voltage converter stage to a second resonant inductor of the resonant choke stage;
coupling a transformer assembly to the resonant choke stage, the transformer assembly comprising a plurality of primary coil assemblies, each primary coil assembly of the plurality of primary coil assemblies comprising:
a first primary winding comprising:
a first node electrically coupled to the resonant choke stage; and
a second node; and
a second primary winding comprising:
a first node; and
a second node electrically coupled to the resonant choke stage;
coupling the second nodes of the first primary windings together;
coupling the first nodes of the second primary windings together; and
winding the first and second resonant inductors about a first leg of a first magnetic core.

13. The method of claim 12 further comprising:
coupling a second voltage converter stage to the resonant choke stage, the second voltage converter stage comprising a pair of voltage outputs; and
coupling a third voltage converter stage to the resonant choke stage, the third voltage converter stage comprising a pair of voltage outputs;
coupling a third resonant inductor to a first voltage output of the pair of voltage outputs of the second voltage converter stage;
coupling a fourth resonant inductor to a second voltage output of the pair of voltage outputs of the second voltage converter stage;
coupling a fifth resonant inductor to a first voltage output of the pair of voltage outputs of the third voltage converter stage; and
coupling a sixth resonant inductor to a second voltage output of the pair of voltage outputs of the third voltage converter stage.

14. The method of claim 13 further comprising:
winding the third and fourth resonant inductors about a second leg of the magnetic core; and
winding the fifth and sixth resonant inductors about a third leg of the magnetic core.

15. The method of claim 12, wherein the transformer assembly further comprises a plurality of secondary coil assemblies, each secondary coil assembly comprising:
a first secondary winding comprising a first node and a second node; and
a second secondary winding comprising a first node and a second node; and
wherein the method further comprises:
coupling the second nodes of the first secondary windings together; and
coupling the first nodes of the second secondary windings together.

16. The method of claim 15 further comprising:
winding the first primary winding of a first primary coil assembly of the plurality of primary coil assemblies and the first secondary winding of a first secondary coil assembly of the plurality of secondary coil assemblies about a first leg of a second magnetic core;
winding the first primary winding of a second primary coil assembly of the plurality of primary coil assemblies and the first secondary winding of a second secondary coil assembly of the plurality of secondary coil assemblies about a second leg of the second magnetic core; and
winding the first primary winding of a third primary coil assembly of the plurality of primary coil assemblies and the first secondary winding of a third secondary coil assembly of the plurality of secondary coil assemblies about a third leg of the second magnetic core.

17. The method of claim 16, further comprising:
winding the second primary winding of the first primary coil assembly of the plurality of primary coil assemblies and the second secondary winding of the first secondary coil assembly of the plurality of secondary coil assemblies about the first leg of the second magnetic core;
winding the second primary winding of the second primary coil assembly of the plurality of primary coil assemblies and the second secondary winding of the second secondary coil assembly of the plurality of secondary coil assemblies about the second leg of the second magnetic core; and
winding the second primary winding of the third primary coil assembly of the plurality of primary coil assemblies and the second secondary winding of the third secondary coil assembly of the plurality of secondary coil assemblies about the third leg of the second magnetic core.

18. The method of claim 16, further comprising:
winding the second primary winding of the first primary coil assembly of the plurality of primary coil assemblies and the second secondary winding of the first secondary coil assembly of the plurality of secondary coil assemblies about a first leg of a third magnetic core;
winding the second primary winding of the second primary coil assembly of the plurality of primary coil assemblies and the second secondary winding of the second secondary coil assembly of the plurality of secondary coil assemblies about a second leg of the third magnetic core; and
winding the second primary winding of the third primary coil assembly of the plurality of primary coil assemblies and the second secondary winding of the third secondary coil assembly of the plurality of secondary coil assemblies about a third leg of the third magnetic core.

19. The method of claim 16, further comprising:
winding the second primary winding of the first primary coil assembly of the plurality of primary coil assemblies and the second secondary winding of the first secondary coil assembly of the plurality of secondary coil assemblies about a fourth leg of the second magnetic core;
winding the second primary winding of the second primary coil assembly of the plurality of primary coil assemblies and the second secondary winding of the second secondary coil assembly of the plurality of secondary coil assemblies about a fifth leg of the second magnetic core; and
winding the second primary winding of the third primary coil assembly of the plurality of primary coil assemblies and the second secondary winding of the third secondary coil assembly of the plurality of secondary coil assemblies about a sixth leg of the second magnetic core.

20. The method of claim 12, wherein the first voltage converter stage comprises:
a first switch and first diode configured as a first half-bridge;
a second switch and second diode configured as a second half-bridge; and
a third switch coupled across the first and second diodes to short circuit the first and second diodes in response to the third switch being in a conductive mode;
wherein the method further comprises:
coupling the first, second, and third switches and the first and second diodes in a three-level LLC circuit arrangement.
